(19) United States
(12) Patent Application Publication
(10) Pub. No.: US 2009/0092384 A1
(43) Pub. Date: Apr. 9, 2009

(54) HIGH FREQUENCY INDUCTION HEATING INSTANTANEOUS TANKLESS WATER HEATERS

(76) Inventors: Shimin Luo, Bristow, VA (US); Yongbing Ding, Taizhou (CN)

Correspondence Address: KED & ASSOCIATES, LLP, P.O. Box 221200, Chantilly, VA, 20153-1200, US

(21) Appl. No.: 12/188,426

(22) Filed: Aug. 8, 2008

Related U.S. Application Data
(60) Provisional application No. 60/954,929, filed on Aug. 9, 2007.

(51) Int. Cl. F24H 1/10; H05B 6/36; F24H 1/00

(52) U.S. Cl. 392/488; 219/672; 392/466

(57) ABSTRACT

A tankless water heater comprising a pipe, at least one coil around the pipe, at least one heating element located within the pipe and responsive to an electromagnetic field generated by the coil, and a controller to apply an alternating current (AC) signal to the at least one coil, the AC signal applied at a predetermined frequency and magnitude to cause the heating element to heat water flowing in the pipe to a predetermined temperature through induction heating.

### BACKGROUND

1. Field

One or more embodiments disclosed herein relate to systems, devices, and methods for heating water.

2. Background

Tankless water heaters have been developed in recent years and are known by a variety of names, including combination or “combi” boilers, continuous flow, inline, flash, or on-demand water heaters. This type of water heater is gaining in popularity mainly for space-saving and energy efficiency reasons. These advantages are achieved by heating water as it flows through a conduit or housing without causing water to be retained internally, except for water that might be present in a heat exchanger coil.

As a practical matter, tankless water heaters may be installed throughout a household at various points-of-use (POU). They also can be used alone or in combination with a centrally located water heater. In some cases, larger tankless models may be used to provide the hot water requirements for an entire house. Whether installed at one or multiple POUs, tankless water heaters provide a continuous flow of hot water and energy savings compared with tank-type heaters, which are only able to provide a finite supply of hot water limited by tank size.

For all of the advantages they provide, tankless water heaters on the market today suffer from significant disadvantages. First, there is a delay between when water flow starts and when a flow detector activates one or more heating elements. This causes cold water to flow before hot water. The flow of cold water under these circumstances is undesirable and is particularly noticeable when a hot water faucet is repeatedly turned on and off by a user.

Second, when activated, tankless water heaters tend to heat idle water in surrounding pipes through the process of convection. Also, tankless water heaters only heat water upon demand so that idle water in the piping is cold. Thus, there is a more apparent “flow delay” for hot water to reach a distant faucet.

Third, because tankless water heaters are inactive when hot water is not being used, they may be incompatible with hot water recirculation systems.

Fourth, tankless water heaters often have minimum flow requirements before the heater is activated. This can create in a gap between the temperature of cold water and the coolest warm temperature that can be achieved with a hot-and-cold water mix. This gap can produce undesirable effects to the user.

Moreover, unlike tank-type heaters, the hot water temperature from a conventional tankless water heater is inversely proportional to the rate of water flow. In other words, the faster the flow, the less time water spends in the heating element. As a result, a certain range of desirable hot water temperatures may not be achievable or achieving a desired temperature with precision may be difficult to control. For example, in certain situations mixing hot and cold water to just the “right” temperature using a single-lever faucet (e.g., while taking a shower) may take a lot of practice to master. A user may therefore consider installing a temperature compensating valve under these circumstances, which can increase costs.

In addition to the foregoing disadvantages, installing a conventional tankless water heating system may be expensive, particularly in retro-fit applications. Also, tankless heaters have demonstrated certain inefficiencies and safety problems that need improvement.

In view of the foregoing considerations, there is a need in the art for a more efficient and effective tankless water heating system and method capable, for example, of not only heating water more quickly than conventional systems and methods but also with greater efficiency, precision, and safety.

### BRIEF DESCRIPTION OF THE DRAWINGS

The embodiments will be described in detail with reference to the following drawings in which like reference numerals refer to like elements wherein:

FIG. 1 is a diagram of a radiator and control circuitry that may be included in one embodiment of a tankless water heater.

FIG. 2 is a cross-sectional view of a water pipe subsystem that may be included with the radiator and control circuit of the embodiment shown in FIG. 1.

FIGS. 3a and 3b is a diagram showing a example of the shape of a pair of non-rusting iron bars that may be incorporated in the embodiment of FIG. 2.

FIG. 4 is a block diagram of additional circuitry that may be used to control one or more of the embodiments of the tankless water heater described herein.

FIG. 5 is a more detailed example of the circuitry shown in FIG. 4 that may be used to control one or more embodiments of the tankless water heater described herein.

### DETAILED DESCRIPTION

One or more embodiments described herein are directed to a heating system and method which operates based on an improved set of qualitative parameters and high-frequency induction heating implemented to instantaneously heat and provide a continuous, unlimited supply of water to a user's faucet, shower, appliance, or other device.

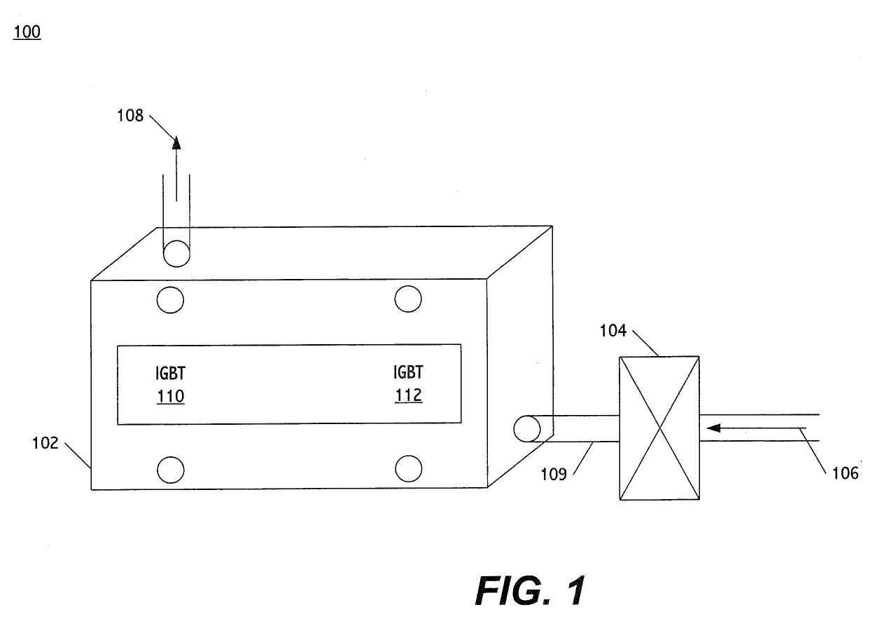

FIG. 1 shows one embodiment of a tankless water heating system 100 that heats water using high-frequency induction heating, and may be implemented to instantaneously heat water using this technique. In accordance with this embodiment, induction heating is performed by heating a metal object placed inside a conduit carrying a supply of flowing water. The metal object is heated by electromagnetic induction, where eddy currents generated within the metal and electrical resistance produces Joule heating which causes the metal to heat the water within the flow line. Induction heating may be performed, for example, by passing high-frequency alternating current through an electromagnet. In addition, or alternatively, induction heat may be generated by magnetic hysteresis losses.

In accordance with one implementation, the system may use series-resonance electromagnetism induction heating technology. This technology provides for high efficiency, energy conservation, safety, reliability, and ease of operation. By using this heating technique, the system can instantaneously provide a safe supply of hot water rapidly. Also, by using this technique, a comparatively stronger magnetic field is generated to magnetize flowing water, thereby making water output from the system more beneficial for human health and satisfying to access.

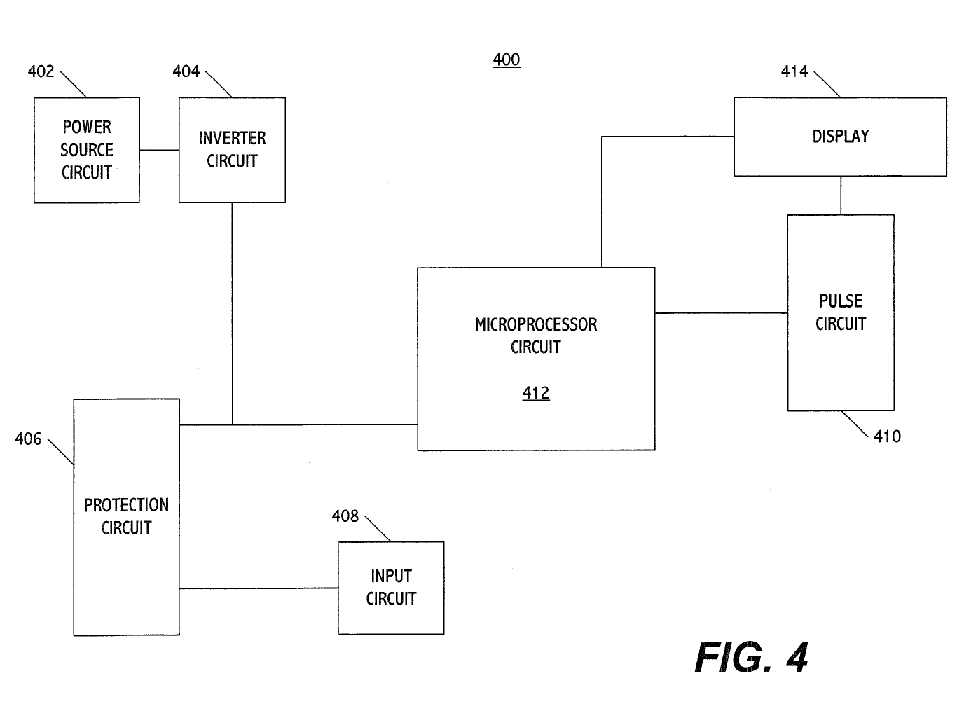

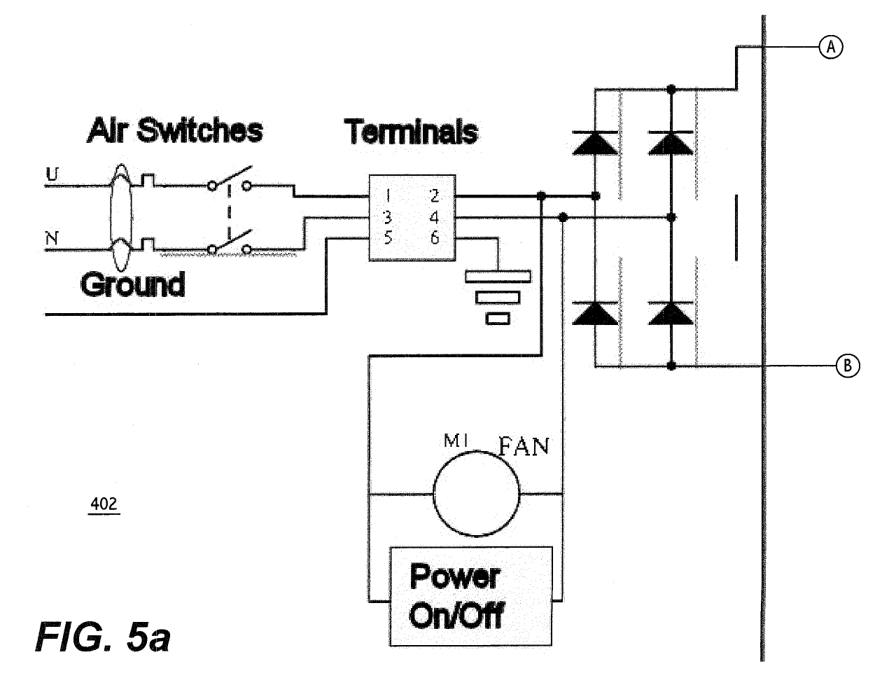

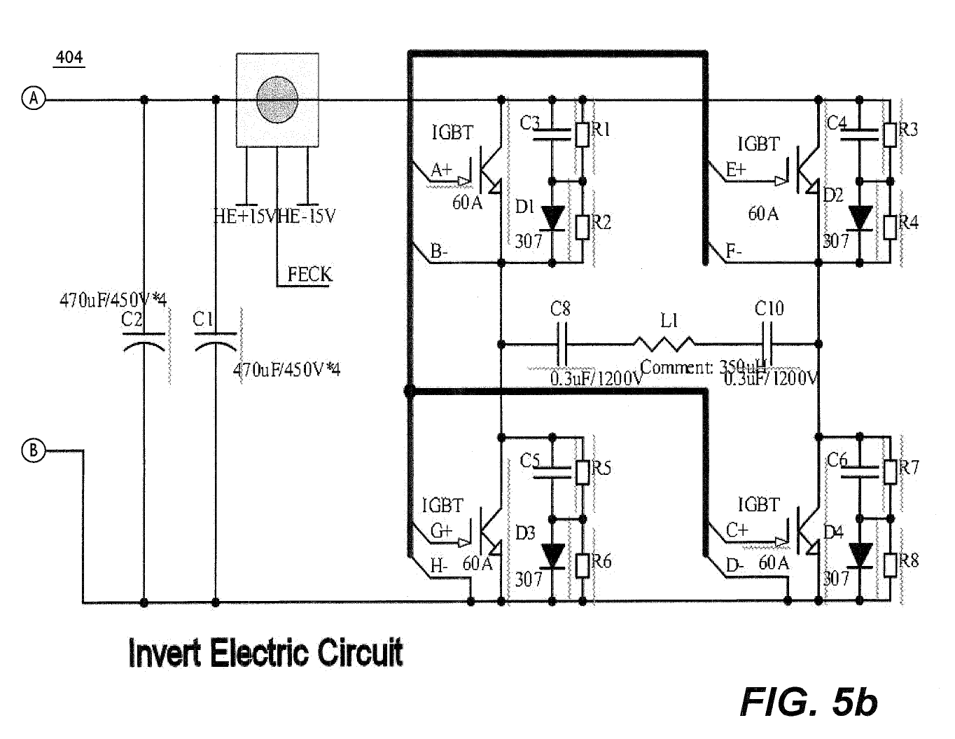

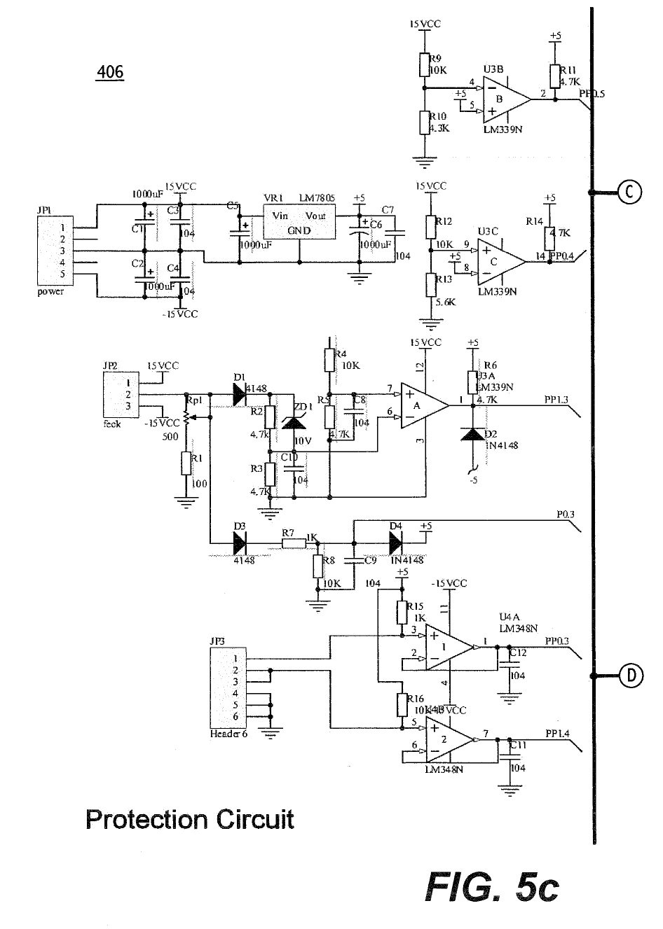

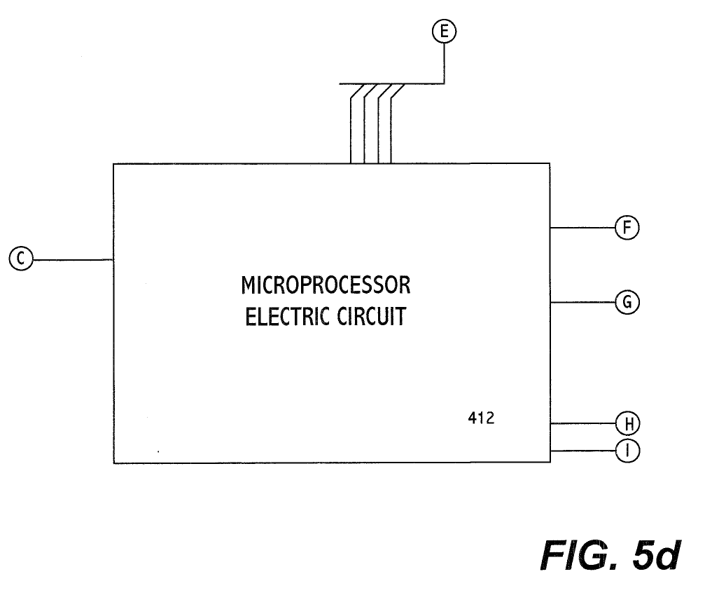

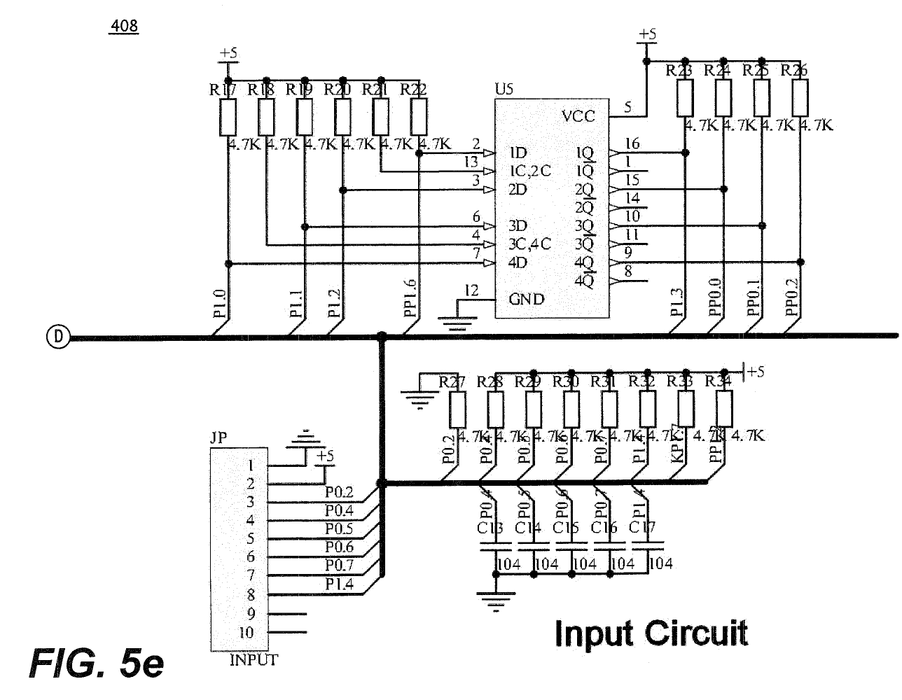

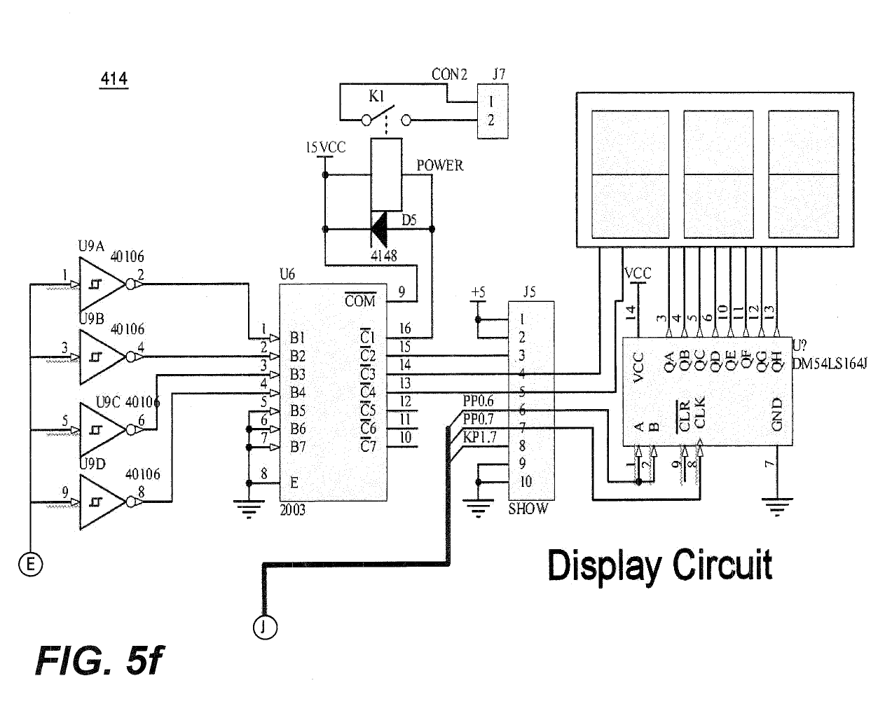

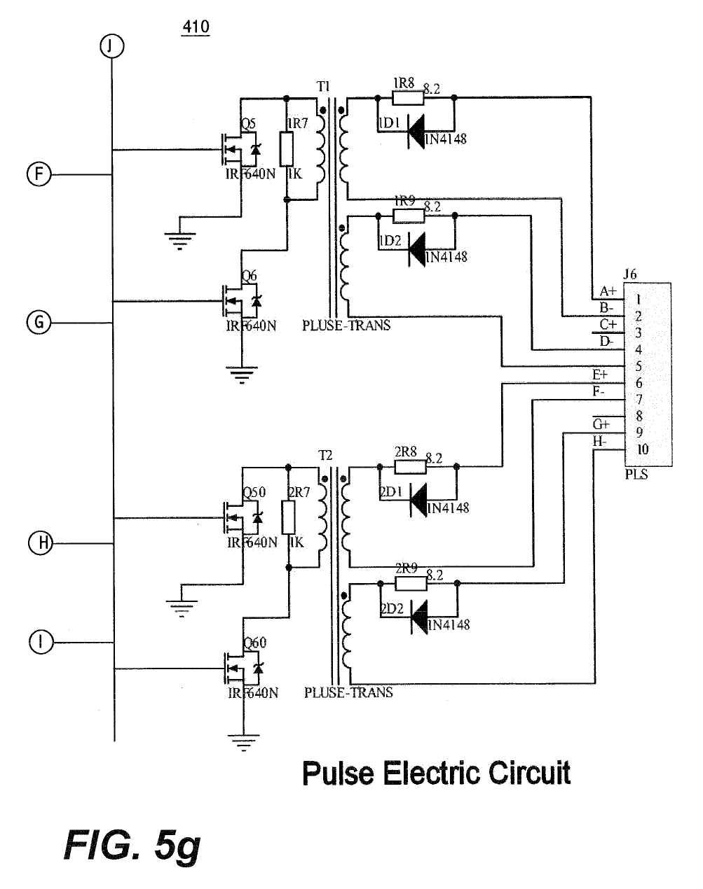

As shown in FIG. 1, the front-end of the system includes a water-cooled radiator 102, an electromagnetic valve 104, a stream of incoming water (e.g., a stream inlet) 106, a water stream outlet 108, a water pipe 109, a first control circuit 110, and a second control circuit 112. The first and second control circuits may be or include insulated-gate bipolar transistors (IGBTs). Each IGBT may be a high-efficiency three-terminal power semiconductor device. The IGBT operates to rapidly switch electrical power as well as other functions in the tankless water heater. These circuits may be included in the circuitry shown in FIG. 4 or 5. In other words, the all or a portion of the circuitry shown in FIG. 4 or 5 may be include in the radiator housing if desired, so that these components may be cooled in the manner described below. However, the radiator may be optional, and the components may also be air-cooled.

The water-cooled radiator 102 serves to cool the IGBTs 110 and 112 and a rectification bridge (not shown), thereby utilizing heat that otherwise would be wasted and at the same time conserving energy. The radiator may have a cube or box shape; however, the radiator and/or housing of the system may come in other shapes to adapt, for example, to convenient spaces in a house where the system can be expected to be implemented.

In operation, cold water from inlet 106 flows through pipe 109 after passing through electromagnetic valve 104. This valve may be made to open, for example, when the system is activated. After passing through the pipe, the cold water flows into the water-cooled radiator 102. The valve may be controlled by one or more of the electrical circuits described herein or by a separate control circuit. In other embodiments, the electromagnetic valve may be considered to be an optional feature.

As water flows through the radiator, a heat transfer takes place from electrical components in the radiator to the water. These components include the IGBTs 110 and 112 previously mentioned as well as, for example, a rectification bridge circuit and/or other components. These components, for example, may be located near or in contact with a conduit through which the water flows inside of the radiator. The conduit may have a straight or curved pipe shape, or may have a vaned structure and/or a series of pathways designed to sink heat from the electrical components.

The transfer of heat that takes place cool the electrical components, while simultaneously heating the cold water in advance of one or more main (e.g., induction) heating stages of the system. The radiator, thus, effects a heat transfer that increases the efficiency the overall system by both cooling electrical components and conserving energy by using heat from electrical components that would dissipate or otherwise be wasted.

Once the water circulates through the radiator, it passes through outlet pipe 108 and on to the main heating stage of the system. The main heating stage heats the water exiting the radiator to a point which corresponds to a desired temperature set, for example, by a user (e.g., as a result of operating a faucet) or an appliance (e.g., a washing machine or dishwasher).

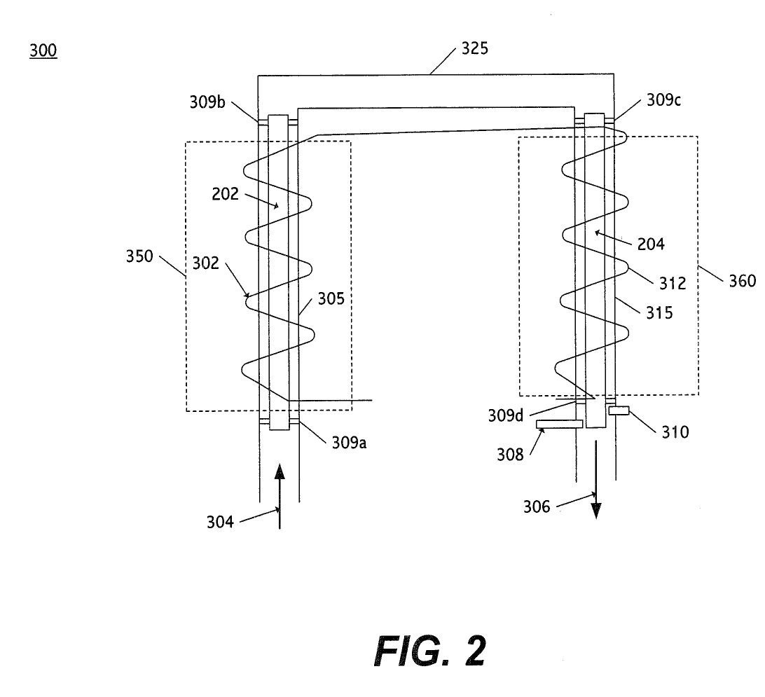

FIG. 2 shows an example of the main heating stage which may be coupled to the outlet pipe 108 in FIG. 1. The main heating stage includes an inlet pipe 304 carrying a flow of water from outlet 108, a first electromagnetic induction heater 350, a second electromagnetic inducting heater 360, and a pipe 325 connecting the two heaters. The main heating stage heats the water flowing through pipe 108 to a desired temperature by the induction heating technique previously discussed. Accordingly, inlet pipe 304 may be coupled to pipe 108 in FIG. 1. Alternatively, if radiator 102 is not used to cool IGBTs 110 and 112, the inlet pipe may be coupled to pipe 109.

The first electromagnetic induction heater 350 includes a first metal element 202 in the flow path of a first segment of pipe 305 coupled to the inlet pipe. The first metal element is preferably in the shape of a bar or other longitudinally oriented structure. Supports 309a and 309b respectively hold the ends of the bar in a mounted position in the pipe. An inductor coil 302 is wrapped around pipe 305 a predetermined number of times, e.g., a number of times sufficient to generate an electromagnetic field relative to bar 202 that heats the water to a desired temperature.

The second electromagnetic induction heater 360 includes a second metal element 204 in the flow path of a second segment of pipe 315. The second metal element may have a shape different from the first metal element or the two may be substantially the same. In accordance with one embodiment, the second metal element is also in the shape of a bar or other longitudinally oriented structure, and similar supports 309c and 309d may hold ends of this bar in a mounted position within pipe 315. An inductor coil 312 is wrapped around this pipe a predetermined number of times, e.g., a number of times sufficient to generate an electromagnetic field relative to bar 204 that further heats the water to a desired temperature.

The first and second pipe segments 305 and 315 may be arranged parallel to one another and may have at least substantially the same length, diameter, and/or water flow rate. A third pipe segment 325 is provided in fluid communication with the first and second pipe segments. As shown, one end of the inductor coil 302 may be coupled to the windings of inductor coil 312, and if so pipe 325 may not include any coil windings. In this case, pipe 325 will serve merely as a conduit to allow water to flow from the first inductor heater to the second inductor heater.

If desired, electromagnetic shielding material may be placed between pipe segments 305 and 315 to prevent one electromagnetic heater from adversely affecting (e.g., through interference) the other electromagnetic heater. Such a material, for example, could prevent the signal frequency in one coil from being altered by the signal frequency of the other coil, thereby ensuring that the water is heated to a desired temperature at the outlet.

In operation, a high-frequency alternating current is input into one end of one of the coils by a control circuit. The input of this current generates electromagnetic fields near both bars sufficient to heat, by induction heating, water flowing through pipe segments 305 and 315. As shown in FIG. 2, the inside diameters of the pipe segments may be greater than outside diameters of bars 202 and 204 to allow water to flow. Bars 202 and 204 are preferably made from a non-rusting metal or metal alloy. The metal may be non-rusting iron or iron alloy or another metal. Non-rusting iron or non-rusting metal may be preferable for some applications in order to prevent harmful or caustic materials from entering the water. Also, one or more of the pipe segments may be polypropylene random (PPR), which may considered to be desirable for some applications as it provides a clean and safe way of transporting water without experiencing leakage. In other embodiments, one or more of the pipe segments may be made from cPVC or another material.

In addition to the foregoing, thermo-element 308 and temperature protection element 310 may be included, for example, proximate a distal end of the bar of the second inductor heater. Thermo-element 308 serves as a quick reacting and accurate temperature sensor which provides feedback signals to control circuits to ensure that water of a desired temperature is output from an outlet 306 of the system. Through these feedback signals, the control circuits are able to regulate the current in the inductor coils to achieve a desired temperature to be output from the system through outlet 306.

The temperature protection element 310 may also detect temperature and perform a similar feedback function in order to provide redundancy, and/or this element may assist in turning off current to the coils when a predetermined safe temperature limit has been exceeded. Additionally, or alternatively, when no water is in the pipes (e.g., when valve 104 in FIG. 1 is closed such that one or more of pipe segments 305, 315, or 325 have no or little water) or when thermo-element 308 is damaged, temperature protection element 310 may send a warning signal to the control circuits of the heater to prevent current from flowing in the inductor coils. This operation will protect against dry burn, which over time may cause the pipe segments to be damaged. Otherwise, under normal operating conditions, temperature protection element 310 may remain in an inactive state.

The control circuits that operate with sensing and protection elements 308 and 310 may employ analog or digital temperature control, although the latter is preferable in order to achieve more precise temperature control of the output water.

As previously mentioned, the metal elements 202 and 204 of each inductor heater may be non-rusting iron bars. The longitudinal shape of these bars increase induction load, thereby allowing for a substantial reduction in the length of the pipe segments in the induction heating stage. As a result, the induction heating stage may serve not only to heat water faster (e.g., almost instantaneously), but also to allow the overall product to be designed with much smaller dimensions.

In order to increase the effectiveness and safety of the heater, insulating material (not shown) may be placed between each of the inductor coils and their respective pipe segments. Use of insulating material may cause a more homogeneous heating profile to be achieved. Also, each inductor coil may be specially processed to endure temperatures up to a predetermined maximum temperature, e.g., 500° C. If such an insulating material is used, one or more of the pipe segments of the heater may be made from a non-resulting metal which, for example, may be similar to or different from the metal from which the non-rusting bars are made as described herein.

An example of how induction heating is performed will now be discussed. In use, heating is enabled by transformation of a residential (e.g., 220 V/60 Hz) power to a predetermined level and frequency of AC current (e.g., 300V/30 kHz). This high frequency AC (or matched AC) is supplied to inductor coil 302 through a corresponding control circuit. The control circuit may include a matching resonance condenser network, and/or an electric circuit resonant capacity, which causes the alternating current to be supplied to coil 302 with high frequency oscillations. In the case where coils 302 and 312 are coupled to one another, the high-frequency alternating current also enters coil 312.

The high-frequency oscillating signal in inductor coil 302 generates a high-frequency formidable turbulent flow rotary field in the pair of non-rusting iron bars 202 and 204. This causes the bars to heat virtually instantaneously to a high temperature proportional to the frequency oscillations and/or magnitude of the applied AC signal. This, in turn, causes the water flowing in pipe segments 305, 315, and 325 to heat instantaneously, thereby avoiding the time delays.

Feedback signals provided by sensors 308 and/or 310 interact with the control circuits to precisely regulate the temperature of the water existing through pipe outlet 306 in order to produce the temperature desired, e.g., responsive to these feedback signals, the control circuits may regulate the oscillating frequency and/or magnitude of the alternating current flowing through the inductor coils to precisely control heating of the water flowing through the pipe segments. As shown in FIG. 2, the pipe segments may be arranged in substantially a U-shape. Moreover, the use of iron in the bars may be more preferable because iron is a type of metal that heats when an electromagnetic field is applied by the inductor coils.

In certain embodiments, one or more electrical parts use advanced and reliable modular IGBTs as primary control components. IGBTs may be preferable because they have proven to be safe and have a longer lifetime than other components. In addition, use of dual temperature protection (e.g., through elements 308 and 310) ensures that dry burn will not occur, and further that no scalding will occur even under anhydrous conditions. Safety of the tankless heater is thereby enhanced by these effects. Moreover, in addition to its safety function, at least thermo-element 308 serves as a temperature-managing component for accurately controlling output water temperature.

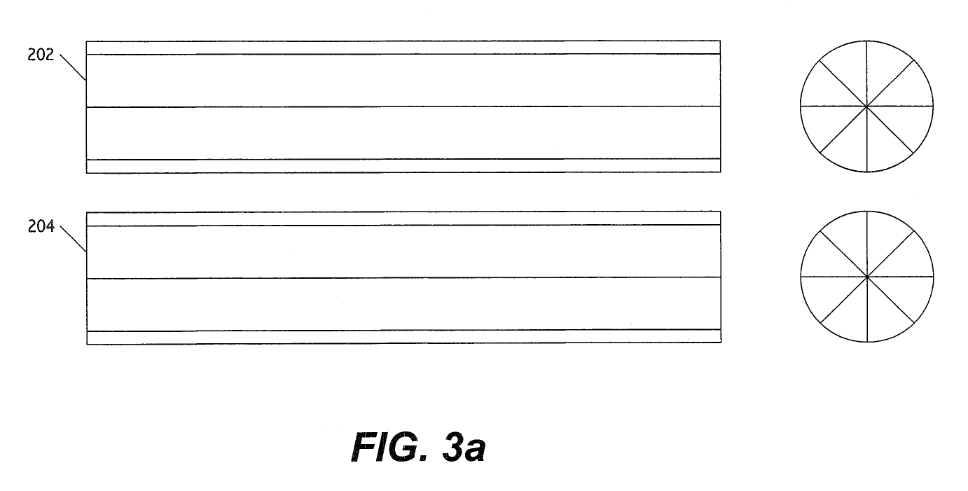

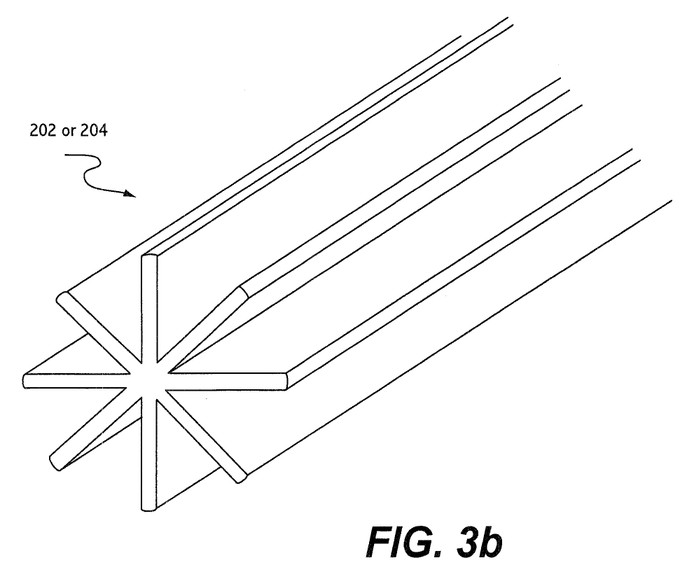

FIGS. 3a and 3b shows one possible configuration of non-rusting iron bars 202 and 204. As shown, each bar may have a same cross-section which, in this example, is a star-type or vane-type cross-section. This configuration is preferable because it allows a high volume of water to flow through the pipe segments (i.e., through the spaces between the vanes) at a high rate, while at the same time exposing the water to a large surface area of the heated bars. Because the time required to heat the water is proportional to the amount of surface area of the bars exposed to the water, the water will heat at a very rapid rate and almost instantaneously to the desired temperature (as regulated by the control circuits).

By way of example, each non-rusting iron bar may be formed from one of or a combination of the following materials: ferritic stainless steel alloy that normally has only chromium SUS430(1Cr17), stainless steel chromium-nickel alloy typically having 18% Cr and 9% Ni SUS304(0Cr18Ni9), 430/1Cr17, and/or cold-rolled stainless steel coil (strip). The SUS430(1Cr17) may serve as the rust-prevention component.

FIG. 4 shows an example of the circuitry that may be used to control a tankless water heater in accordance with one or more of the foregoing embodiments. This circuitry includes a power source circuit 402, an inverter circuit 404, a protection circuit 406, an input circuit 408, a pulse circuit 410, a microprocessor circuit 412. and a display 414. FIG. 5 shows a more detailed example of the circuitry shown in FIG. 4.

In operation, power source circuit 402 performs a current transformation. This may involve, for example, transforming residential 220V/60 Hz signal to 300V/30 kHz Alternating Current (or AC). This AC signal is then provided either at this frequency or another (e.g., higher) transformed frequency to the induction-heating stage of the heater, e.g., to inductor coils 302 and 312.

In order to change the low-frequency 60 Hz signal into the high-frequency 30 kHz signal, first the 60 Hz signal may be transformed into a DC signal. As a precautionary measure, to avoid disturbing other equipments, power source circuit 402 may be designed with an enhanced filter function. The DC signal may then be transformed back into an AC signal at the 30 kHz frequency by controlling the switching of inverter circuit 404. Once this transformation takes place, the resulting AC signal at 30 kHz is supplied to the inductor coils.

In one or more embodiments, disturbance to the power source and therefore any potential impact on the power network may be minimized by using high-efficiency series resonance technology. As a safety precaution, a control circuit (e.g., protection circuit 406) may turn off the AC current to the inductor coils if a leakage detector (e.g., one that detects whether water is leaking from any of the pipes) is activated.

The protection circuit 406 may also protect against a variety of other adverse conditions including but not limited to voltage fluctuations, electric current oversize, hyperpyrexia, overheating conditions, power surges, and/or other disturbances. These protections are designed to protect the heater when it is not operating under normal or expected operating conditions. For example, protection circuit 406 may receive feedback signals from detectors 308 and 310 to control AC power cut-off, temperature regulation, and overheating conditions. The protection circuit 406 may be coupled to microprocessor circuit 412, which actually generates the signals for cutting off power or regulating AC current to the coils or for performing other protective functions when a fault condition is detected or another adjustment is required for proper operation of the heater. The heater 100 may also be grounded to prevent a user from shock.

The input circuit 408, pulse electric circuit 410, and microprocessor circuit 412 may perform additional control functions. For example, the input circuit 408 is coupled to the protection circuit 406 and may serve to provide reference, bias, and/or other signals for ensuring proper operation of the protection circuit 406. The pulse circuit may provides signals which assist the microprocessor in controlling the display, for controlling switching of the inverter circuit, and/or for performing other functions. The display 414 displays the temperature settings of the heater, the actual temperature of output water, and/or a variety of other information relating to operation of the heater. The display may also receive or cooperate to receive inputs from a user in adjusting various parameters of the heater. In this way, the heater may be customized to the specific requirements of the user or a particular application.

In some embodiments, the system 100, of the FIG. 1, has a magnetic shielding function to ensure no emission thereby preventing any injury to the human body.

In the embodiment of FIG. 2, two electromagnetic heaters are shown with an intervening pipe to form a substantially a U-shaped configuration. In other embodiments, only one electromagnetic heater (e.g., heater 360) may be used, or if multiple heaters are used the heaters may be linearly aligned. In other embodiments, one or more electromagnetic heaters may be provided in a spiral or helical configuration or in other shapes to match, for example, the space into which the heater is to be installed within a home, office, or business. In other embodiments, more than two electromagnetic heaters may be used in various configurations. In still other embodiments, pipe segment 325 may be coupled to 309 and come back up, and/or pipe segments 350 and 360 may end up on the same side.

Another embodiment of the water heater may include or be used with a tank. For example, one embodiment may include a small tank (e.g., 7 oz.) to hold a supply of water that is either cold or warmed or heated by one or both of the electromagnetic heaters. In the embodiment of FIG. 2, the tank may be included before electromagnetic heater 350, between heaters 350 and 360 (e.g., in fluid communication with pipe 325), or after heater 360. If a small tank is used, the water heater may be considered to be a substantially tankless water heater.

A water heater in accordance with one or more of the aforementioned embodiments outperforms conventional heaters (including tankless water heaters) in at least the following ways. First, the combination of tankless and high-frequency induction heating provides a continuous, unlimited supply of virtually instantaneously heated water to serve the needs of users and/or appliances in a household. The use of induction heating also prevents time delays for receiving hot water associated with conventional heaters, and also reduces or eliminates scale built-up which increases the operational lifetime of the system. This is especially helpful in reducing the effects of hard water.

In addition, the embodiments of the tankless water heater described herein is can regulate with precision a desired temperature of the hot water, for example, by regulating the oscillation frequency of the AC current input into the inductor coils. Also, the use of non-rusting bars made from a material responsive to induction heating which may allow the heater to be smaller in size compared with conventional heaters. However, in other embodiments, the heater may actually be larger than conventional electric tankless. But, even in these embodiments the water heater described herein will likely outperform conventional tankless heaters based on the other advantages described herein.

Also, a tankless water heater in accordance with the foregoing embodiments include a number of protection circuits that, for example, automatically turns off power if leakage occurs, dry burn is detected, or an overheating condition is sensed. If overheating is sensed, the control circuits of the heater may alternatively adjust the oscillation frequency and/or magnitude of the AC current into the inductor coils as a way of reducing the temperature of the water.

The tankless water heater may also use all digital circuitry to control temperature and may have a modular design to allow for easy service and maintenance.

Also, the tankless water heater is highly efficient, safe, reliable and easily operable. And, through a unique closed-loop design, power to the inductor coils and therefore heating of the water may be automatically adjusted when water flow changes within a certain range thereby ensuring output water temperature to stay constant.

Additional advantages include the absence of scaling buildup, which reduces efficiency and causes the heating element to fail over time. Also, the temperature can be accurately controlled, and a user can set the temperature so that users are no longer required to add cold water to hot water in order to achieve a desired temperature. For example, in conventional systems, in order to achieve a desired temperature hot water must be heated to a default temperature of 120°. Cold water is then added to this pre-heated hot water in order to achieve a desired temperature. The embodiments of the water heater described herein do not realize these disadvantages because no pre-heating or mixing of cold and hot water is required. By using electromagnetic induction heaters, only one supply of water may be heated to precisely the desired temperature. As a result, the embodiments described herein are more energy efficient and at the same time promote water conservation.

Also, the use of induction heating is advantageous because it does not have cause the energy loss due to part of energy become radiant heat as in conventional coil heating situation.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A water heater, comprising:
a pipe;
at least one coil around the pipe;
at least one heating element located within the pipe and responsive to an electromagnetic field generated by the coil; and
a controller to apply an alternating current (AC) signal to the at least one coil, the AC signal applied at a predetermined frequency and magnitude to cause the heating element to heat water flowing in the pipe to a predetermined temperature through induction heating.

2. The water heater of claim 1, further comprising:
a first induction heating section comprising:
(a) a first heating element located in a first segment of the pipe, and
(b) a first coil around the first segment of the pipe; and
a second induction heating section comprising:
(c) a second heating element located in a second segment of the pipe, and
(d) a second coil around the second segment of the pipe, wherein the first segment of the pipe is coupled to the second segment of the pipe and wherein the first and second heating elements cooperate to heat water flowing through the pipe to said predetermined temperature.

3. The water heater of claim 2, wherein the controller applies the AC signal to the first and second coils to cause the first and second heating elements to heat water flowing through respective ones of the first and second pipe segments by induction heating.

4. The water heater of claim 2, wherein the first coil is coupled to the second coil.

5. The water heater of claim 2, wherein a third segment of the pipe is coupled between the first and second segments and wherein the third segment does not include a coil for performing induction heating.

6. The water heater of claim 1, wherein the heating element is a metal bar responsive to the electromagnetic field generated by the coil for performing induction heating.

7. The water heater of claim 6, wherein the metal bar is a non-rusting iron bar.

8. The water heater of claim 7, wherein the iron bar has a cross-section that includes a plurality of vanes that project from a central portion of the bar, and wherein spaces between the vanes provide passageways that allow water to flow through the pipe.

9. The water heater of claim 8, wherein the passageways are substantially parallel to one another and linearly arranged along the bar.

10. The water heater of claim 1, further comprising:
at least one protection circuit to control the AC signal to the coil when a fault condition is detected.

11. The water heater of claim 10, wherein the protection circuit changes at least one of a magnitude or frequency of the AC signal when the fault condition is detected, to thereby change an amount of induction heating of the water flowing in the pipe.

12. The water heater of claim 1, further comprising:
a converter circuit to convert a power supply signal into the AC signal to be applied to the at least one coil, wherein the power supply signal is at a frequency lower than the predetermined frequency of the AC signal and wherein the converter converts the lower frequency of the power supply signal up to the predetermined frequency of the AC signal applied to the at least one coil.

13. The water heater of claim 1, further comprising:
a regulator having one or more control switches; and
another pipe which passes through the regulator, wherein the other pipe is coupled to the pipe containing the coil and wherein a heater transfer takes place from one or more electronic components in the regulator and water flowing through the other pipe.

14. The water heater of claim 1, wherein the water heater is a tankless water heater.

15. A method for heating water, comprising:
providing a heating element in a pipe that is responsive to an electromagnetic field generated by a coil around the pipe; and
applying an alternating current (AC) signal to the coil, the AC signal applied at a predetermined frequency or magnitude sufficient to cause the heating element to heat water flowing through the pipe to a predetermined temperature through induction heating.

16. The method of claim 15, wherein the heating element is a metal bar responsive to the electromagnetic field generated by the coil for performing induction heating.

17. The method of claim 16, wherein the metal bar is a non-rusting iron bar.

18. The method of claim 17, wherein the iron bar has a cross-section that includes a plurality of vanes that project from a central portion of the bar, and wherein spaces between the vanes provide passageways that allow water to flow in the pipe.

19. The method of claim 18, said applying includes:
applying the AC signal to a first coil around a first segment of pipe containing a first heating element; and
applying the AC signal to a second coil around a second segment of pipe containing a second heating element, wherein the first and second segments or pipe are coupled to one another.

20. The method of claim 15, further comprising:
activating a protection circuit to regulate or block the AC signal from reaching the coil when a fault condition is detected.
